(19) United States
(12) Patent Application Publication
(10) Pub. No.: US 2008/0168511 A1
(43) Pub. Date: Jul. 10, 2008

(54) Metadata Scheme For Personalized Data Broadcasting Service And, Method And System For Data Broadcasting Service Using The Same

(75) Inventors: Yong-Ho Kim, Daejeon (KR); Han-Kyu Lee, Daejeon (KR); Jin-Soo Choi, Daejeon (KR); Jin-Woo Hong, Daejeon (KR)

Correspondence Address: LADAS & PARRY LLP, 224 SOUTH MICHIGAN AVENUE, SUITE 1600, CHICAGO, IL, 60604, US

(73) Assignee: Electronics And Telecommunications Research Institute, Daejeon (KR)

(21) Appl. No.: 11/813,441

(22) PCT Filed: Jan. 6, 2006
(86) PCT No.: PCT/KR2006/000061

§ 371 Date: Jul. 6, 2007

(30) Foreign Application Priority Data
Jan. 7, 2005 (KR) 10-2005-0001858
Jan. 18, 2005 (KR) 10-2005-0004642

(51) Int. Cl. H04N 7/173

(52) U.S. Cl. 725/105

(57) ABSTRACT

Provided is a personalized data broadcasting service, more particularly, a metadata scheme for a personalized data broadcasting service, a data broadcasting service providing method using the metadata scheme, and a system thereof. A metadata forming method of the present research includes the steps of: a) generating an interactive content service (InteractiveContentService) element which describes whether a data broadcasting is a uni-directional service or a bi-directional service; b) generating a rendering style (RenderingStyle) element which describes properties of the data broadcasting displayed on a screen of a user; c) generating an update cycle (UpdateCycle) element which describes a content update period of the data broadcasting; and d) generating a package, an item or a component on the data broadcasting service information including the three elements generated above.

### TECHNICAL FIELD

The present invention relates to a metadata scheme for providing a personalized data broadcasting service so that users can watch desired broadcasting contents anytime anyplace with diverse kinds of terminals, a method for providing a data broadcasting service, and a system thereof.

### BACKGROUND ART

A personalized broadcasting is standardized according to broadcasting environments by the TV-Anytime (TVA) forum based on metadata-based contents consumption defined by the Moving Picture Experts Group (MPEG)-7 and 21. The metadata specification for the personalized broadcasting is divided into TVA Phase 1 (TVA-1) and TVA Phase 2 (TVA-2).

The TVA-1 deals with diverse audio/video (AV) content services using metadata and acquisition of additional metadata through an interactive network.

The TVA-2 mainly deals with package services using diverse contents such as data broadcasting, targeting services providing contents suitable for diverse user environments, and contents sharing between terminals in a home network environment.

Particularly, various content information should be described in metadata to provide a package service. The metadata include common information that can be described in common and specific information that should be described differently according to properties of each content.

When a data broadcasting service is described in metadata, a metadata scheme suitable for a data broadcasting is in need to describe unique information of the data broadcasting and the difference between data broadcasting contents and ordinary contents needs to be reflected to authoring and transmission of metadata.

### DISCLOSURE

### Technical Problem

It is, therefore, an object of the present invention to provide a metadata scheme for providing a personalized data broadcasting service.

It is another object of the present invention to provide a method for representing a data broadcasting service as a TV-Anytime (TVA) package model.

It is another object of the present invention to provide a method for providing a personalized data broadcasting service using the metadata scheme, and a system thereof.

Other objects and advantages of the present invention will be understood by the following description and embodiments. Also, it is obvious to those skilled in the art that the objects and advantages of the present invention can be realized by the means as claimed and combinations thereof.

### Technical Solution

In accordance with one aspect of the present invention, there is provided a method for forming metadata describing data broadcasting service information, which includes the steps of: a) generating an interactive content service (InteractiveContentService) element which describes whether a data broadcasting is a uni-directional service or a bi-directional service; b) generating a rendering style (RenderingStyle) element which describes properties of the data broadcasting displayed on a screen of a user; c) generating an update cycle (UpdateCycle) element which describes a content update period of the data broadcasting; and d) generating a package, an item or a component on the data broadcasting service information including the three elements generated above.

In accordance with one aspect of the present invention, there is provided a method for providing a data broadcasting service, which includes the steps of: a) forming a package including an interactive content service element which describes whether a data broadcasting is a uni-directional service or a bi-directional service, a rendering style element which describes properties of the data broadcasting displayed on a screen of a user, and an update cycle element which describes a content update period of the data broadcasting; b) transmitting and receiving the package; and c) showing data broadcasting service information to a user by using the data broadcasting service metadata included in the received package and receiving a related content.

In accordance with one aspect of the present invention, there is provided a data broadcasting service system, which includes: a data broadcasting providing unit for providing a package including an interactive content service element which describes whether a data broadcasting is a uni-directional service or a bi-directional service, a rendering style element which describes properties of the data broadcasting displayed on a screen of a user, and an update cycle element which describes a content update period of the data broadcasting; and a user terminal for receiving the package, providing data broadcasting service information to a user by using the data broadcasting service metadata included in the received package and receiving contents of the data broadcasting service.

### ADVANTAGEOUS EFFECTS

The present invention can provide metadata that can send useful information to users or user terminals in a personalized data broadcasting service. Also, the present invention can be applied to a data broadcasting service cookbook considering even a step of authoring and acquiring schema in a data broadcasting service including a targeting function.

### DESCRIPTION OF DRAWINGS

The above and other objects and features of the present invention will become apparent from the following description of the preferred embodiments given in conjunction with the accompanying drawings, in which:

FIG. 1 shows a basic scheme of TV-Anytime Phase 2 (TVA-2) metadata schema;

FIG. 2 shows metadata schemes of ‘Descriptor’ elements in the TVA-2 metadata schema;

FIG. 3 shows a structure of a metadata schema for data broadcasting in accordance with an embodiment of the present invention; and

FIG. 4 is a block diagram describing a personalized data broadcasting service system in accordance with an embodiment of the present invention.

### BEST MODE FOR THE INVENTION

Other objects and aspects of the invention will become apparent from the following description of the embodiments with reference to the accompanying drawings, which is set forth hereinafter. Accordingly, the technological concept of the present invention can be easily realized by those skilled in the art. Also, when it is considered that detailed description on a related art may obscure the points of the present invention, the description will not be provided. Hereinafter, the present invention will be described with reference to the accompanying drawings and embodiments.

First of all, the format and structure of metadata will be described hereinafter to describe information on a data broadcasting service in metadata.

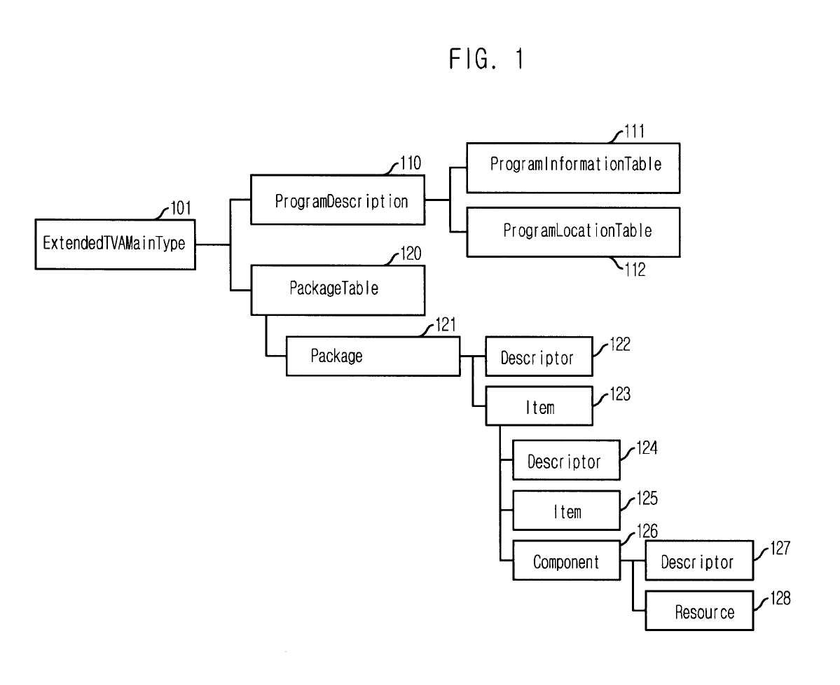

FIGS. 1 through 3 show TV-Anytime (TVA) metadata in connection with a data broadcasting service. Each component denotes an element of metadata and only part of low-rank elements of an element are presented in the drawing. In other words, an element ‘ExtendedTVAMainType’ 101 includes ‘ProgramDescription’ 110, ‘PackageTable’ 120 and others as its low-rank elements.

FIG. 1 shows a scheme of metadata describing a main ‘ExtendedTVAMainType’ element 101 and program information and metadata describing package information. The TVA-2 metadata include TVA-1 metadata. In the drawing, the ‘ProgramDescription’ 110 corresponds to the TVA-1 metadata and the ‘PackageTable’ 120 corresponds to TVA-2 metadata. The ‘PackageTable’ 120 is an element for describing a package model and it includes a ‘Package’ 121, an ‘Item’ 123, and a ‘Component’ 126.

The ‘Component’ 126 is the lowest-rank element of the package model and it includes one ‘Resource’ 128. The ‘Resource’ 128 corresponds to an actual physical file or stream, that is, a content such as video/audio (AV) file, stream, an image file and a text file, becomes the ‘Resource’. The ‘Item’ 123 is formed in a reflexive structure including the ‘Component’ 126 and a low-rank ‘Item’ 125. The ‘Item’ 123 may describe the relationship between information on the group of elements and the ‘Component’ 126 or the low-rank ‘Item’ 125. The ‘Package’ 121 denotes a group of ‘Item’ elements 123 and it is used as a unit selected by a user or a user terminal.

Each of the ‘Package’ 121, the ‘Item’ 123 and the ‘Component’ 126 includes a ‘Descriptor’ element 122, 124 or 127 for describing detailed information as its low-rank element. Although the ‘Descriptor’ elements have the same structure but they signify different meaning according to their position. The ‘Descriptor’ 122 in the low-rank of the ‘Package’ 121 describes information on the ‘Package’ 121, and the ‘Descriptor’ 124 in the low-rank of the ‘Item’ 123 describes information on the ‘Item’ 123. The ‘Descriptor’ 127 in the low rank of the ‘Component’ 126 describes information on the ‘Component’ 126.

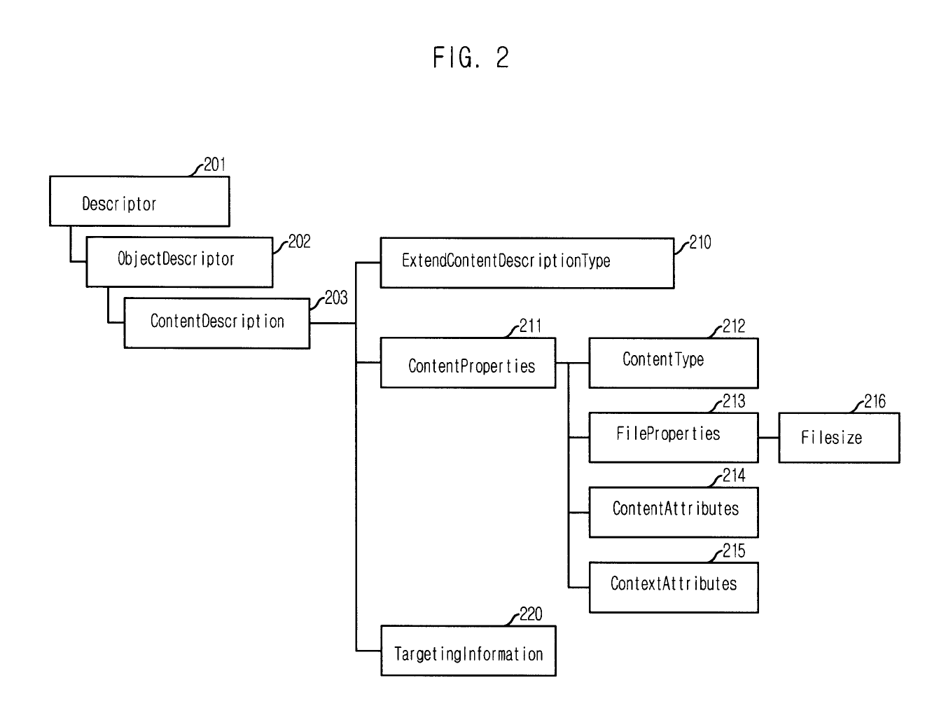

FIG. 2 shows metadata schemes of the ‘Descriptor’ elements 122, 124, 127 and 201. The ‘Descriptor’ 201 includes ‘ContentDescription’ 203 for describing content information in the low-rank. The ‘ContentDescription’ 203 includes ‘ExtendedContentDescriptionType’ 210 for describing general information and ‘ContentProperties’ 211 for describing information of each content of each type.

The ‘ExtendedContentDescriptionType’ 210 includes elements for describing information that is available in common in any contents, such as title, synopsis, keywords, genre, language, producer, and related media.

The ‘ContentProperties’ 211 includes ‘ContentType’ 212 for describing the kind of a content, ‘FileProperties’ 213 for representing attributes of a file, ‘ContentAttributes’ 214 for describing contents according to formal classification, and ‘ContextAttributes’ 215 for describing a content according to context-based classification.

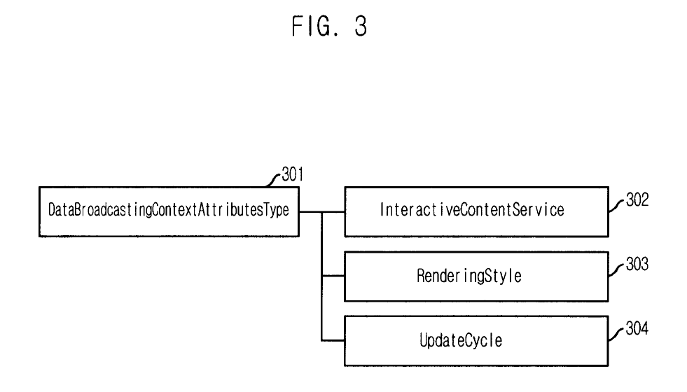

Particularly, the ‘ContextAttributes’ 215 can be used diverse types of metadata-according to whether a content is a data broadcasting content, an ordinary application content, or a game content. In the present invention, metadata for describing a data broadcasting content will be described, which is shown in FIG. 3.

Metadata for describing a data broadcasting service is ‘DataBroadcastignContextAttributesType,’ which is a data broadcasting type, 301, and it can be used as a type of ‘ContextAttributes’ 215.

The ‘DataBroadcastignContextAttributesType’ 301 includes three elements as its low-rank elements: an InteractiveContentService element 302, a RenderingStyle element 303, and an UpdateCycle element 304.

The InteractiveContentService element 302 indicates whether a data broadcasting is a uni-directional service or a bi-directional service. The uni-directional service is a data broadcasting service not through the Internet network but through a broadcasting network. The bi-directional service is an interactive broadcasting service transmitting data on responses from a user and result thereof not only through a broadcasting network but also through the Internet network. The data form of the InteractiveContentService element 302 is Boolean. Thus it has a value between ‘true’ and ‘false.’ When the value is ‘true,’ it means that the service is an interactive service. When it is ‘false,’ it means that the service is a uni-directional service.

The RenderingStyle element 303 describes attributes when a data broadcasting is displayed on a screen to be shown to a user. It includes two attributes, which are FullScreen and Transparency. The FullScreen attribute indicates whether the data broadcasting is shown on the entire screen or on part of the screen. The data form of the FullScreen attribute is Boolean. When the data broadcasting is displayed on the entire screen, the value is ‘true.’ When it is displayed on part of the screen, the value is ‘false.’ The Transparency attribute indicates whether the data broadcasting should be shown on the screen transparently overlapped with a main AV program or whether it should be shown in a separate region from the main AV program. Its data form is Boolean, too. When the data broadcasting is shown transparently, the value is ‘true.’ When it is shown in a separate region of the screen, the value is ‘false.’

The UpdateCycle element 304 describes how frequently a content or a data broadcasting content is updated. It indicates the period of content update. The data form of the UpdateCycle element 304 is duration that is formed of year, month, day, hour, minute and second, which are basically used in the eXtensible Markup Language (XML). When the value of the UpdateCycle element 304 is ‘0’ (‘PT0S’), it means that the corresponding content is not updated.

The core part of the present invention includes the ‘DataBroadcastignContextAttributesType’ 301 the InteractiveContentService element 302, the RenderingStyle element 303, and the UpdateCycle element 304.

Information on a data broadcasting service and a content can be described as follows.

Data broadcasting service information is described in the ‘Package’ 121, which means at least one data broadcasting application. The data broadcasting service information is described in the ‘Descriptor’ 122, which is a low-rank element of the ‘Package’ 121. The ‘ContentType’ 207 which is a low-rank element of the ‘Descriptor’ 122 should include a ‘Name’ element having a value of ‘DataBroadcasting’ based on a format described in a ‘ContentTypeCS,’ which is a content type classification code. Detailed information on the data broadcasting service is described by using ‘ContextAttributes’ 215 and ‘ExtendedContentDescriptionType’ 210.

Detailed information on the main AV program in connection with the data broadcasting service is described in ‘ProgramInformationTable’ 111, which is a low-rank element of the ‘ProgramDescription’ 110. The relationship between the main program and the data broadcasting is described by using the ‘Package’ 121 and ‘RelatedMaterial,’ which is a low-rank element of the ‘ProgramInformationTable’ 111. Schedule information of the main program and the data broadcasting service is described by using ‘ProgramLocationTable’ 112, and it may be the same or different according to the kind of the data broadcasting service.

When data broadcasting contents are to be grouped according to consumption conditions or sequences, contents of each group are bound by the ‘Item’ 123, and information on the grouping is described in the low-rank ‘Descriptor’ 124. In the ‘Descriptor’ 124, General information on each group is described in ‘ExtendedContentDescriptionType’ 210 and specific information on the data broadcasting is described in ‘ContextAttributes’ 210 inheriting the ‘DataBroadcastignContextAttributesType’ 301, after inserting the ‘Name’ element having a value of ‘DataBroadcasting’ into the ‘ContentType’ 207, just as the ‘Package’ 121. The usage type or condition for targeting of each group are described in ‘TargetingInformation’ 220, and content information of each group is described in ‘Component’ 126, which is a low-rank element of the ‘Item’ 123. This will be described in detail, hereinafter.

Crid information for the acquisition of a content, i.e., download, is described in the ‘Resource’ 128, which is a low-rank element of the ‘Component’ 126. Detailed information of a content is described in the ‘Descriptor’ 127, which is a low-rank element of the ‘Component’ 126. Among them, specific information of the data broadcasting is described in the same way as the ‘Package’ 121 and the ‘Item’ 123.

The data broadcasting service may be one ‘Package’ 121 as one consumption unit itself, or the entire data broadcasting service itself can be an ‘Item’ 123 or a ‘Component’ 126 as one content. This will be determined based on the entire program structure.

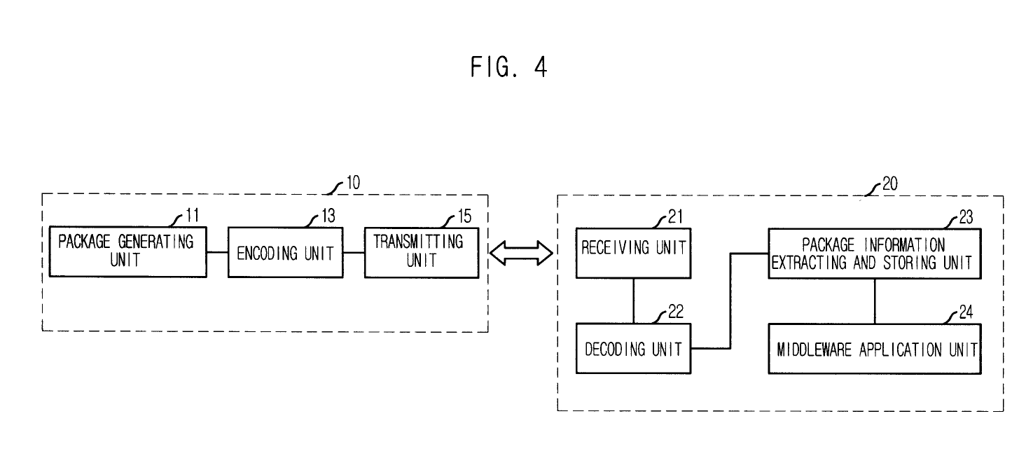

FIG. 4 is a block diagram describing a personalized data broadcasting service system in accordance with an embodiment of the present invention.

Referring to FIG. 4, the data broadcasting service system includes a data broadcasting provider 10 and a user terminal 20. The data broadcasting provider 10 provides a data broadcasting package which includes an interactive content service element (InteractiveContentService), a rendering style element (RenderingStyle), and an update cycle element (UpdateCycle). The interactive content service element (InteractiveContentService) describes whether the data broadcasting is a uni-directional service or a bi-directional service. The rendering style element (RenderingStyle) describes how the data broadcasting content is shown in a user's screen. The update cycle element (UpdateCycle) describes the update period of the data broadcasting content.

The user terminal 20 receives the package, receives the data broadcasting service by using data broadcasting service metadata included in the received package, and transmitting related information to the user.

The data broadcasting provider 10 includes a package generating unit 11, an encoding unit 13 and a transmitting unit 15. The package generating unit 11 generates a package including information on a personalized data broadcasting service by using the metadata whose scheme is suggested in the present invention. The encoding unit 13 encodes the generated package based on an appropriate protocol. The transmitting unit 15 transmits encoded data through a broadcasting network.

The user terminal 20 includes a receiving unit 21 for receiving the encoded data of the package, a decoding unit for decoding the received data, a package information extracting and storing unit 23 for acquiring various information included in the package, i.e., package information, from the decoded data and storing the package information, and a middleware application unit 24 for transmitting the information on the data broadcasting by using the package information and acquiring an application.

The package received by the user terminal 20 includes the information on the ‘DataBroadcastignContextAttributesType’ 301.

The method of the present invention can be realized as a program and stored in a computer-readable recording medium such as CD-ROM, RAM, ROM, a floppy disk, a hard disk, and a magneto-optical disk. Since this process can be easily implemented by those skilled in the art of the present invention, detailed description on it will not be provided herein.

While the present invention has been described with respect to certain preferred embodiments, it will be apparent to those skilled in the art that various changes and modifications may be made without departing from the scope of the invention as defined in the following claims.

What is claimed is:

1. A method for forming metadata describing data broadcasting service information, comprising the steps of:
a) generating an interactive content service (InteractiveContentService) element which describes whether a data broadcasting is a uni-directional service or a bi-directional service;
b) generating a rendering style (RenderingStyle) element which describes properties of the data broadcasting displayed on a screen of a user;
c) generating an update cycle (UpdateCycle) element which describes a content update period of the data broadcasting; and
d) generating a package, an item or a component on the data broadcasting service information including the three elements generated above.

2. The method as recited in claim 1, wherein the interactive content service element has a format of Boolean data which have a value ‘true’ when the package, item or component including the interactive content service element is of an interactive data broadcasting service; or have a value ‘false’ when the package, item or component including the interactive content service element is of a uni-directional data broadcasting service.

3. The method as recited in claim 1, wherein the rendering style element includes information on whether or not the data broadcasting is displayed on the entire screen of the user, and information on transparency.

4. The method as recited in claim 3, wherein the information on whether or not the data broadcasting is displayed on the entire screen of the user has a value ‘true’ when the package, item or component including the rendering style element is displayed on the entire screen; or the information on whether or not the data broadcasting is displayed on the entire screen of the user has a value ‘false’ when the package, item or component including the rendering style element is displayed on part of the entire screen.

5. The method as recited in claim 3, wherein the information on transparency includes information on whether the package, item or component including the rendering style element is displayed transparently overlapped with another video program or displayed separately from the video program.

6. The method as recited in claim 1, wherein the update cycle element is displayed in an eXtensible Markup Language (XML) data format representing time and when update is not performed, the update cycle element has a value ‘0.’

7. A metadata scheme for a data broadcasting service, comprising:
an interactive content service (InteractiveContentService) element which describes whether a data broadcasting is a uni-directional service or a bi-directional service;
a rendering style (RenderingStyle) element which describes properties of the data broadcasting displayed on a screen of a user;
an update cycle (UpdateCycle) element which describes a content update period of the data broadcasting; and
a package, an item or a component on the data broadcasting service information including the three elements.

8. A method for providing a data broadcasting service, comprising the steps of:
a) forming a package including an interactive content service element which describes whether a data broadcasting is a uni-directional service or a bi-directional service, a rendering style element which describes properties of the data broadcasting displayed on a screen of a user, and an update cycle element which describes a content update period of the data broadcasting;
b) transmitting and receiving the package; and
c) showing data broadcasting service information to a user by using the data broadcasting service metadata included in the received package and receiving a related content.

9. The method as recited in claim 8, wherein the interactive content service element has a format of Boolean data which have a value ‘true’ when the package, item or component including the interactive content service element is of an interactive data broadcasting service; or have a value ‘false’ when the package, item or component including the interactive content service element is of a uni-directional data broadcasting service.

10. The method as recited in claim 8, wherein the rendering style element includes information on whether or not the data broadcasting is displayed on the entire screen of the user, and information on transparency.

11. The method as recited in claim 10, wherein the information on whether or not the data broadcasting is displayed on the entire screen of the user has a value ‘true’ when the package, item or component including the rendering style element is displayed on the entire screen; or the information on whether or not the data broadcasting is displayed on the entire screen of the user has a value ‘false’ when the package, item or component including the rendering style element is displayed on part of the entire screen.

12. The method as recited in claim 10, wherein the information on transparency includes information on whether the package, item or component including the rendering style element is displayed transparently overlapped with another video program or displayed separately from the video program.

13. The method as recited in claim 8, wherein the update cycle element is displayed in an eXtensible Markup Language (XML) data format representing time and when update is not performed, the update cycle element has a value ‘0.’

14. A data broadcasting service system, comprising:
a data broadcasting providing unit for providing a package including an interactive content service element which describes whether a data broadcasting is a uni-directional service or a bi-directional service, a rendering style element which describes properties of the data broadcasting displayed on a screen of a user, and an update cycle element which describes a content update period of the data broadcasting; and
a user terminal for receiving the package, providing data broadcasting service information to a user by using the data broadcasting service metadata included in the received package and receiving contents of the data broadcasting service.

15. A user terminal for receiving a data broadcasting service in a data broadcasting service system, comprising:
a receiving unit for receiving an encoded package which includes an interactive content service element which describes whether a data broadcasting is a uni-directional service or a bi-directional service, a rendering style element which describes properties of the data broadcasting displayed on a screen of a user, and an update cycle element which describes a content update period of the data broadcasting;
a decoding unit for decoding the encoded package to thereby obtain decoded data;
a package information extracting and storing unit for acquiring various information included in the package, which is package information, from the decoded data and storing the package information; and
a middleware application unit for transmitting information on the data broadcasting by using the package information and acquiring an application.

16. The user terminal as recited in claim 15, wherein the interactive content service element has a format of Boolean data which have a value ‘true’ when the package, item or component including the interactive content service element is of an interactive data broadcasting service; or have a value ‘false’ when the package, item or component including the interactive content service element is of a uni-directional data broadcasting service.

17. The user terminal as recited in claim 15, wherein the rendering style element includes information on whether or not the data broadcasting is displayed on the entire screen of the user, and information on transparency.

18. The user terminal as recited in claim 15, wherein the information on whether or not the data broadcasting is displayed on the entire screen of the user has a value ‘true’ when the package, item or component including the rendering style element is displayed on the entire screen; or the information on whether or not the data broadcasting is displayed on the entire screen of the user has a value ‘false’ when the package, item or component including the rendering style element is displayed on part of the entire screen.

19. The user terminal as recited in claim 15, wherein the information on transparency includes information on whether the package, item or component including the rendering style element is displayed transparently overlapped with another video program or displayed separately from the video program.

20. The user terminal as recited in claim 15, wherein the update cycle element is displayed in an eXtensible Markup Language (XML) data format representing time and when update is not performed, the update cycle element has a value ‘0.’
